(19) United States
(12) Patent Application Publication
(10) Pub. No.: US 2024/0144523 A1
(43) Pub. Date: May 2, 2024

(54) INFRARED CAMERA-BASED 3D TRACKING USING ONE OR MORE REFLECTIVE MARKERS

(71) Applicant: GOOGLE LLC, Mountain View, CA (US)

(72) Inventors: Ruofei Du, San Francisco, CA (US); Ananta Narayanan Balaji, Queenstown (SG); David Kim, Zug (CH); Clayton Merrill Kimber, Raharney (IE)

(21) Appl. No.: 18/495,483

(22) Filed: Oct. 26, 2023

Related U.S. Application Data
(60) Provisional application No. 63/381,062, filed on Oct. 26, 2022.

(51) Int. Cl. G06T 7/73; G06T 7/80

(52) U.S. Cl. CPC G06T 7/73; G06T 7/80; G06T 2207/10012; G06T 2207/10048; G06T 2207/20084; G06T 2207/30204

(57) ABSTRACT

According to an aspect, a method may include receiving two-dimensional (2D) positions of at least one of a first reflective marker or a second reflective marker of a physical component, estimating a three-dimensional (3D) position of the first reflective marker and a 3D position of the second reflective marker based on the 2D positions, and computing an orientation of the physical component in 3D space based on the 3D position of the first reflective marker, the 3D position of the second reflective marker, and positioning information of the first and second reflective markers in the physical component.

### CROSS REFERENCE TO RELATED APPLICATION

This application claims the benefit of U.S. Provisional Application 63/381,062, filed Oct. 26, 2022, the disclosure of which is incorporated herein by reference in its entirety.

### TECHNICAL FIELD

This description generally relates to infrared camera-based three-dimensional (3D) position tracking using one or more reflective markers.

### BACKGROUND

Devices such as computers, smartphones, augmented reality (AR)/virtual reality (VR) headsets, etc. may track the position of objects. However, some conventional 3D tracking mechanisms may use a relatively large amount of CPU power caused by computer resource intensive tracking algorithms, high-powered cameras, and/or controllers having electronics and batteries.

### SUMMARY

This disclosure relates to an object tracker configured to detect an orientation (e.g., 3 Degrees of Freedom (3DoF), 4DoF, 5DoF, or 6DoF) of a physical component (e.g., a controller, stylus, tape, etc.) in 3D space in a manner that is relatively accurate while consuming a relatively low amount of power. In some examples, a head-mounted display device (e.g., an augmented reality (AR) device, a virtual reality (VR) device) includes the object tracker. The physical component may include one or more reflective markers (e.g., reflective spheres). The object tracker may include a stereo pair of infrared cameras and an array of illuminators (e.g., light-emitting diode (LED) emitters) for each infrared camera. The stereo pair of infrared cameras may detect two-dimensional (2D) positions of the reflective marker(s). In some examples, the 2D positions are the (x, y) coordinates in their respective camera plane. The object tracker includes a controller configured to estimate the 3D positions (e.g., the real-world positions) of the reflective markers using the 2D positions and to compute the orientation of the physical component using the 3D positions and positioning information of the reflective markers in the physical component. The positioning information may be the positions (e.g., x, y, z coordinates) of the reflective markers in a coordinate frame of the physical component.

In some aspects, the techniques described herein relate to a method including: receiving two-dimensional (2D) positions of at least one of a first reflective marker or a second reflective marker of a physical component; estimating a three-dimensional (3D) position of the first reflective marker and a 3D position of the second reflective marker based on the 2D positions; and computing an orientation of the physical component in 3D space based on the 3D position of the first reflective marker, the 3D position of the second reflective marker, and positioning information of the first and second reflective markers in the physical component.

In some aspects, the techniques described herein relate to a computing device including: a stereo pair of cameras configured to detect two-dimensional (2D) positions of at least one of a first reflective marker or a second reflective marker of a physical component; and a controller configured to: estimate a three-dimensional (3D) position of the first reflective marker and a 3D position of the second reflective marker based on the 2D positions; and compute an orientation of the physical component in 3D space based on the 3D position of the first reflective marker, the 3D position of the second reflective marker, and positioning information of the first and second reflective markers in the physical component.

In some aspects, the techniques described herein relate to a computer program product storing executable instructions that when executed by at least one processor cause the at least one processor to execute operations, the operations including: receiving at least one two-dimensional (2D) position of at least one reflective marker of a physical component; estimating at least one three-dimensional (3D) position of the at least one reflective marker based on the at least one 2D position; and computing an orientation of the physical component in 3D space based on the at least one 3D position and positioning information of the at least one reflective marker in the physical component.

The details of one or more implementations are set forth in the accompanying drawings and the description below. Other features will be apparent from the description and drawings, and from the claims.

### BRIEF DESCRIPTION OF THE DRAWINGS

FIG. 1A depicts an object tracker that computes an orientation of a passive controller according to an aspect.

FIG. 1B illustrates an example computing device having the object tracker according to an aspect.

FIG. 1C illustrates an example of a stereo depth estimator of the object tracker according to an aspect.

FIG. 1D illustrates an example of three-dimensional positions before and after Kalman filtering according to an aspect.

FIG. 1E illustrates a stereo camera calibrator of the object tracker according to an aspect.

FIG. 1F illustrates a camera model according to an aspect.

FIG. 1G illustrates an example of a controller with an occlusion corrector of the object tracker according to an aspect.

FIG. 2 illustrates an example of an infrared camera with an array of illuminators according to an aspect.

FIG. 3A illustrates a front view of a head-mounted wearable device according to an aspect.

FIG. 3B illustrates a back view of the head-mounted wearable device according to an aspect.

FIG. 4 illustrates an example of a passive controller as a stylus according to an aspect.

FIG. 5 illustrates an example of a passive controller as a pen according to an aspect.

FIG. 6 illustrates an example of a passive controller as ring members according to an aspect.

FIG. 7 illustrates example operations of an object tracker according to an aspect.

### DETAILED DESCRIPTION

This disclosure relates to an object tracker configured to detect an orientation (e.g., 3 Degrees of Freedom (3DoF), 4DoF, 5DoF, or 6DoF) of a physical component (e.g., a controller, stylus, tape, etc.) in 3D space in a manner that is relatively accurate while consuming a relatively low amount of power. The object tracker may be included as part of a computing device such as a head-mounted display device (e.g., an augmented reality (AR) device, a virtual reality (VR) device). The physical component may include one or more reflective markers (e.g., reflective spheres). In some examples, the physical component is held or worn by a user. The physical component may be a stylus, a wristband, one or more ring members, or any other component that includes reflective marker(s). In some examples, the physical component is a passive controller. A passive controller may be a component that does not consume power, e.g., does not require charging or re-charging and/or electrical power-consuming components. In some examples, a user may use the physical component to interact with virtual content. The object tracker may include a stereo pair of infrared cameras and an array of illuminators (e.g., LED emitters) for each infrared camera. The stereo pair of infrared cameras detects two-dimensional (2D) positions of the reflective marker(s). In some examples, the 2D positions are the (x, y) coordinates in their respective camera plane. The 2D position of the reflective marker may be a position in a plane associated with a light detector (e.g., a camera) detecting light reflected by the reflective marker. For example, the 2D position of the reflective marker is a position of an image of the reflective marker in an image plane of a camera receiving light reflected by the at least one reflective marker. The object tracker includes a controller configured to estimate the 3D positions (e.g., the real-world positions) of the reflective markers using the 2D positions and to compute the orientation of the physical component using the 3D positions and positioning information of the physical component. The positioning information may be the positions (e.g., x, y, z coordinates) of the reflective markers in a coordinate frame of the physical component.

To detect the orientation of the physical component, a computing device (e.g., head-mounted display device) includes a pair of stereo infrared) cameras (e.g., a first (e.g., right) camera, a second (e.g., left) camera)), and each infrared camera is associated with one or more illuminators (e.g., infrared light emitting diode (LED) emitters). Instead of infrared cameras other camera types or light detectors may be used, e.g., cameras configured for detecting visible light. The physical component may include one, two, three, or more than three reflective markers configured to reflect infrared (IR) lights from the illuminators, and each infrared camera is configured to receive the reflected IR light and to detect the 2D positions of the reflective marker(s) on the physical component. The computing device includes a controller (e.g., a microcontroller) configured to estimate the 3D positions of the reflective markers from the 2D positions and estimate the orientation of the physical component based on the 3D positions and the positioning information. The infrared cameras may generate the 2D positions of the tracked reflective markers, while 3D triangulation of the 2D points is processed by a relatively small controller on the computing device.

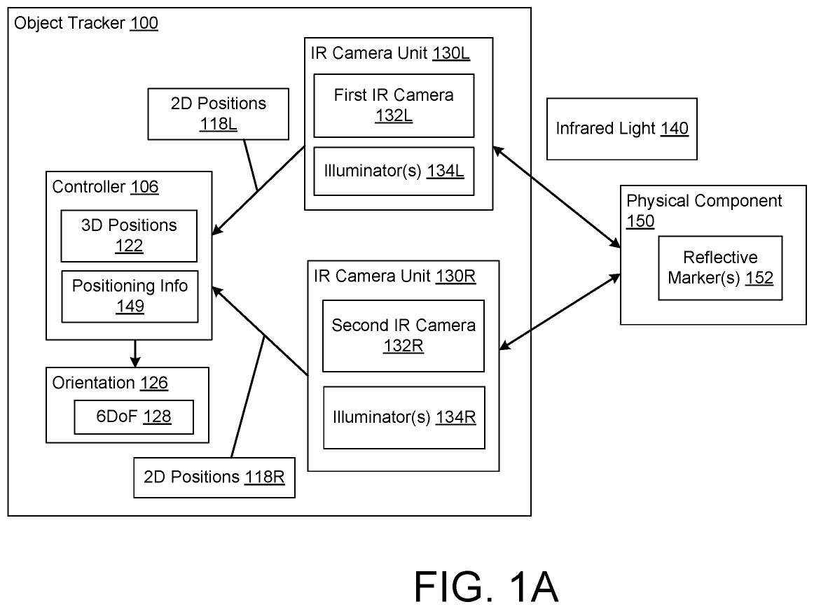

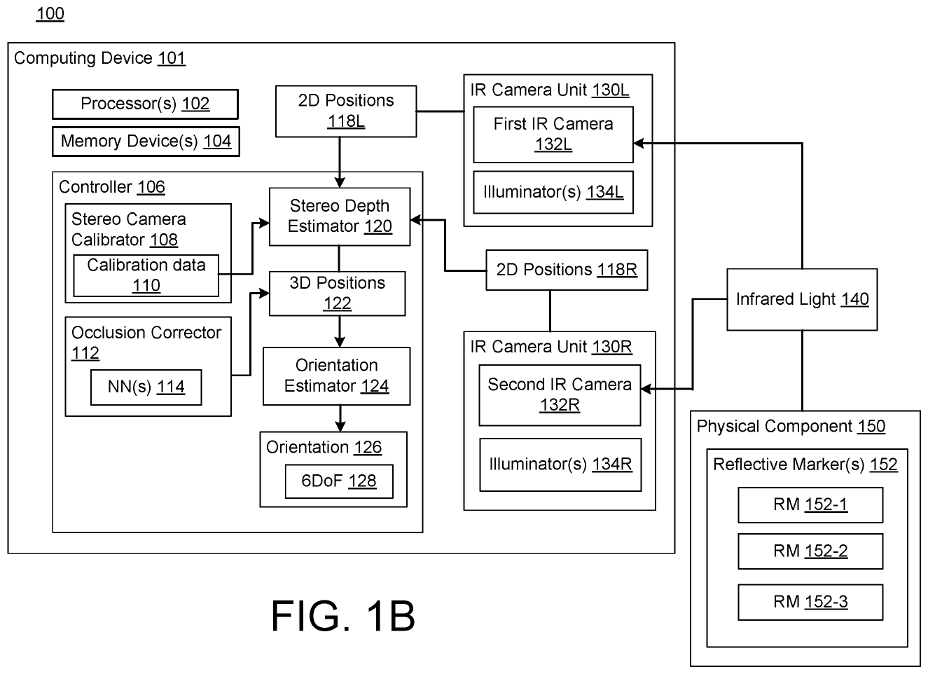

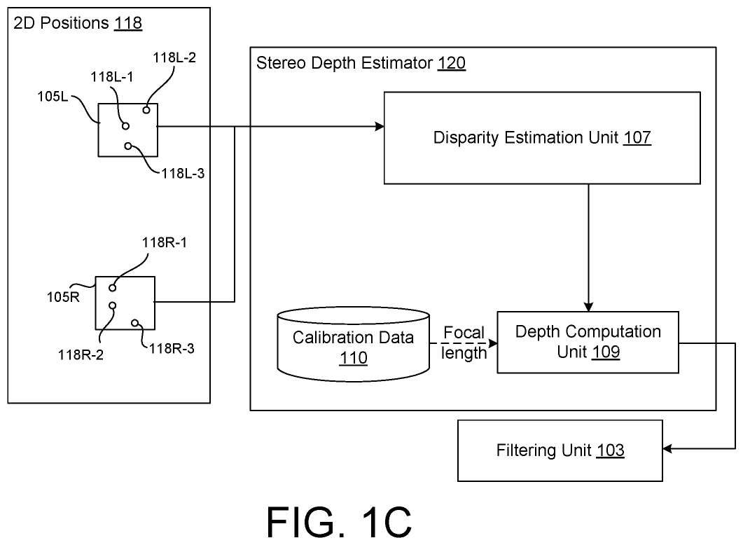

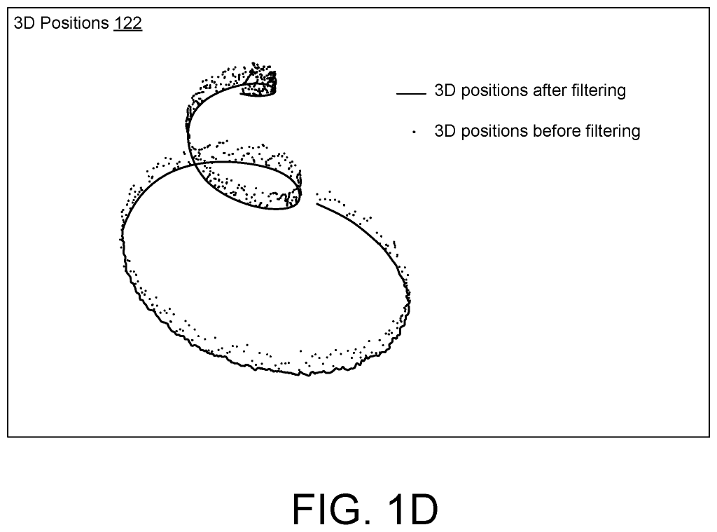

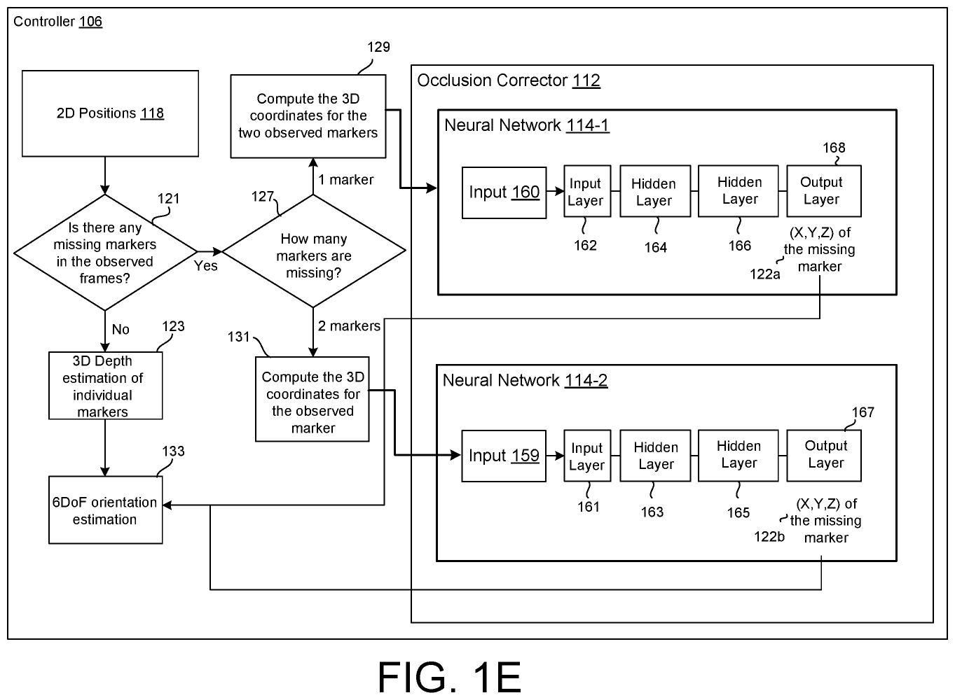

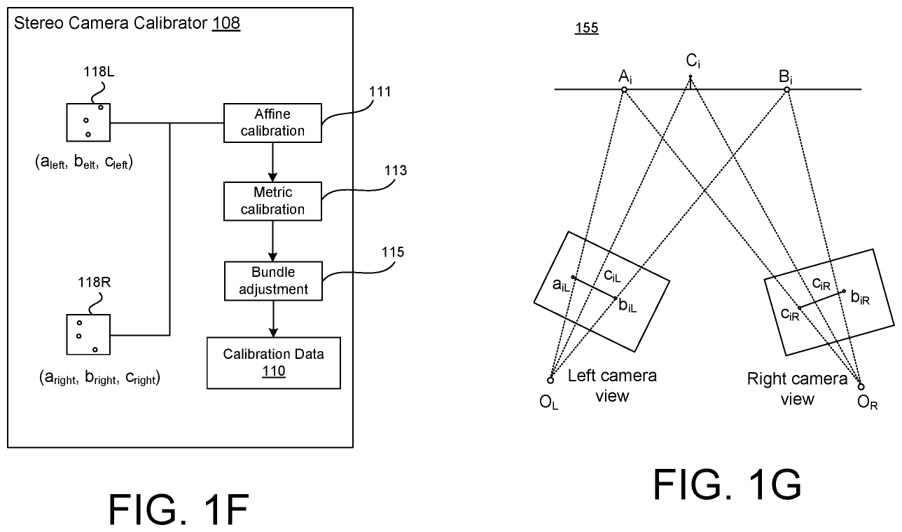

FIGS. 1A through 1G illustrate an object tracker 100 according to an aspect. The object tracker 100 includes a controller 106, an infrared (IR) camera unit 130L, and an IR camera unit 130R. In some examples, the object tracker 100 is configured to compute (e.g., periodically compute, continuously compute) an orientation 126 of a physical component 150. In some examples, the object tracker 100 is configured to compute the orientation 126 of the physical component 150 as the physical component 150 moves in three-dimensional (3D) space.

The orientation 126 may include positional data of the physical component 150. In some examples, the positional data includes a 3D position of the physical component 150 (or reflective marker(s) 152). The 3D position may include the 3D coordinates (e.g., x, y, and z values) of the physical component 150. In some examples, the orientation 126 includes rotational data of the physical component 150. The rotation data may include the rotation on the x-axis, y-axis, and z-axis. In some examples, the orientation 126 includes a six degrees of freedom (6DoF) orientation 128 of the physical component 150. In some examples, the 6DoF orientation 128 includes positional data on the x-axis, y-axis, and z-axis and rotational data on the x-axis (roll), y-axis (pitch) and z-axis (yaw). However, the orientation 126 may include 4DoF or 5DoF orientation (e.g., positional data on the x-axis, y-axis, and z-axis and rotational data on one or two of an x-axis (roll), y-axis (pitch) and z-axis (yaw). In some examples, the orientation 126 includes positional data on the x-axis, y-axis, and z-axis. In some examples, the orientation 126 includes a 3DoF orientation.

The object tracker 100 may be incorporated into a wide variety of devices, systems, or applications such as wearable devices, smartphones, laptops, virtual reality (VR) devices, augmented reality (AR) devices, or generally any type of computing device. The orientation 126 detected by the object tracker 100 may be used in a wide variety of VR and/or AR applications or any type of application that can use the orientation 126 of an object as an input. In some examples, a user may use the physical component 150 to create 2D or 3D drawings, take notes, operate 3D user interfaces, interact with real and/or virtual objects, and/or detect or control the use or operation of real world objects or virtual objects. In some examples, the object tracker 100 is configured to support a home sensing application, where the orientation 126 (e.g., the 3D position of reflective marker(s) 152) is used to render an interface at the location of an object (e.g., an object attached with the reflective marker(s) 152).

In some examples, the physical component 150 is a passive controller. A passive controller may be a component that does not require charging or recharging. In some examples, the physical component 150 may not have a battery and may be devoid of electrical components that consume power. The physical component 150 includes one or more reflective markers 152. A reflective marker 152 may be a component configured to reflect infrared light 140. In some examples, the reflective marker(s) 152 includes a metal material. In some examples, the reflective marker(s) 152 includes reflective spheres. However, the reflective marker(s) 152 may have a wide variety of shapes. In some examples, a reflective sphere has the shape of an obtuse triangle, which may assist with estimating a 6DoF orientation 128. In some examples, a reflective marker 152 includes a reflective adhesive, tape, or coating. In some examples, the physical component 150 includes reflective marker(s) 152 and one or more electrical components. In some examples, the physical component 150 includes reflective marker(s) 152, a battery, and reflective marker(s) 152. In some examples, the physical component 150 is a hand-held device. In some examples, the physical component 150 includes one or more user controls. In some examples, the physical component 150 is a wearable device (e.g., a wristband, ring member(s)). In some examples, reflective markers 152 are attached to a physical object (e.g., an appliance, a door, etc.). In some examples, the reflective markers 152 are included on a reflective adhesive (e.g., reflective tape), which may be attached to a physical object. In some examples, the reflective markers 152 are included on a reflective coating that is applied to a physical object. In some examples, the reflective markers 152 are components of the physical object.

In some examples, the physical component 150 includes three reflective markers 152, e.g., a reflective marker 152-1, a reflective marker 152-2, and a reflective marker 152-3. In some examples, the physical component 150 includes two reflective markers 152. In some examples, the physical component 150 includes a single reflective marker 152. In some examples, the physical component 150 includes more than three reflective markers 152 such as four, five, six, or any number greater than six. The reflective markers 152 on the physical component 150 may have varied sizes (e.g., diameter, surface area, etc.). For example, the reflective marker 152-1 has a first size, the reflective marker 152-2 has a second size, and the reflective marker 152-3 has a third size, where the first through third sizes are different from each other. In some examples, the reflective markers 152 have the same shape. In some examples, the reflective markers 152 have different shapes.

The physical component 150 may include one or more components coupled to the reflective markers 152. In some examples, the physical component 150 is configured to be held by a user. In some examples, the physical component 150 is configured to be coupled to a physical object (e.g., a reflective tape coupled to a device such as a microwave, refrigerator, etc.). In some examples, the physical component 150 includes a stylus having an elongated member with reflective markers 152 coupled to the elongated member. In some examples, a user may use the stylus to create 2D or 3D drawings, take notes, operate 3D user interfaces, interact with real and/or virtual objects, and/or detect or control the use or operation of real world objects or virtual objects.

In some examples, the physical component 150 includes a pen structure configured to enable a first reflective marker (e.g., reflective marker 152-1) to move with respect to a second reflective marker (e.g., reflective marker 152-2) when force is applied to an end of the pen structure (e.g., when the user presses the pen structure against a surface). When the distance between the first reflective marker and the second reflective marker is reduced, the controller 106 may activate tracking of the physical component 150 (e.g., to create a 2D drawing).

In some examples, the physical component 150 includes a first ring member (e.g., capable of fitting around a person's finger) with a reflective marker 152-1 and a second ring member (e.g., capable of fitting around another figure) with a reflective marker 152-1). A user may manipulate the distance between the first and second ring members to operate 3D user interfaces, interact with real and/or virtual objects, and/or detect or control the use or operation of real world objects or virtual objects.

In some examples, referring to FIG. 1B, the object tracker 100 may be incorporated into a computing device 101. The computing device 101 may be any type of device having one or more processors 102 and one or more memory devices 104. In some examples, the computing device 101 includes a mobile computing device. In some examples, the computing device 101 includes a smartphone. In some examples, the computing device 101 includes a wearable device. The computing device 101 may be a head-mounted display device. The wearable device may include a head-mounted display (HMD) device such as an optical head-mounted display (OHMD) device, a transparent heads-up display (HUD) device, a VR device, an AR device, or other devices such as goggles or headsets having sensors, display, and computing capabilities. In some examples, the wearable device includes smart glasses. Smart glasses are an optical head-mounted display device designed in the shape of a pair of eyeglasses. For example, smart glasses are glasses that add information (e.g., project a display) alongside what the wearer views through the glasses. In some examples, the smart glasses include a frame holding a pair of lenses and an arm portion coupled to the frame (e.g., via a hinge), where the IR camera unit 130L and the IR camera unit 130R are coupled to the frame and the controller 106 is coupled to the arm portion. In some examples, the computing device 101 includes two or more devices, e.g., a head-mounted display device and a computer, where the computer is connected (e.g., wirelessly connected) to the head-mounted display device. In some examples, one or more sub-subcomponents (e.g., stereo camera calibrator 108, occlusion corrector 112, stereo depth estimator 120, and/or orientation estimator 124) of the controller 150 are executed by the computer.

The computing device 101 includes the IR camera unit 130L and the IR camera unit 130R. The IR camera unit 130L is configured to detect 2D positions 118L of the reflective markers 152, and, in some examples, the sizes of the reflective markers 152. The IR camera unit 130L transmits the 2D positions 118L (and, in some examples, the sizes) to the controller 106. The IR camera unit 130R is configured to detect the 2D positions 118R of the reflective markers 152, and, in some examples, the sizes of the reflective markers 152. The IR camera unit 130R transmits the 2D positions 118R (and, in some examples, the sizes) to the controller 106. In some examples, since each reflective marker 152 has a distinct size, the size parameter of each detected reflective marker 152 may assist the controller 106 to match correspondences between each reflective marker 152. In some examples, the controller 106 is configured to transmit the orientation 126 to an application (e.g., executing on the AR/VR device (e.g., head-mounted display device) or executing on another computing device (e.g., smartphone, laptop, desktop, wearable device, gaming console, etc.) that is connected (e.g., Wi-Fi connection, short-range communication link, etc.) to the AR/VR device. The application may be an operating system, a native application that is installed on the operating system, a web application, a mobile application, or generally any type of program that uses the orientation 126 as an input.

The IR camera unit 130L includes a first infrared camera 132L and one or more illuminators 134L. The illuminator(s) 134L may be infrared light sources. In some examples, the first infrared camera 132L is referred to as a left camera. The illuminator(s) 134L may include infrared light emitting diode (LED) emitters. In some examples, the illuminator(s) 134L include a plurality of illuminators 134L (e.g., two, three, four, or any number greater than four) that are positioned around the first infrared camera 132L. In some examples, the illuminators 134L are arranged in a circular infrared LED array. In some examples, the illuminators 134L includes a circular array of four LED emitters, which, in some examples, can provide a field of view equal to or greater than a threshold level (e.g., one hundred degrees, one hundred and twenty degrees, one hundred and fifty degrees, etc.).

The first infrared camera 132L receives infrared light 140 reflected by the reflective marker(s) 152 and detects the 2D position(s) 118L of the reflective marker(s) 152 based on the infrared light 140. For example, the reflective marker(s) 152, when illuminated with an infrared light source (e.g., the illuminator(s) 134L), reflects back the infrared light 140 in the same direction. The first infrared camera 132L receives the reflected infrared light 140 and may detect the 2D positions 118L of the reflective marker(s) 152, e.g., the 2D position 118L of the reflective marker 152-1, the 2D position 118L of the reflective marker 152-2, and the 2D position 118L of the reflective marker 152-3. The 2D position 118L includes a 2D coordinate (e.g., x, y) of a respective reflective marker 152 in a camera plane 105L associated with the first infrared camera 132L.

The IR camera unit 130R includes a second infrared camera 132R and one or more illuminators 134R. In some examples, the second infrared camera 132R is referred to as a right camera. The first infrared camera 132L and the second infrared camera 132R may be a pair of stereo infrared cameras. The illuminator(s) 134R may include light emitting diode (LED) emitters. In some examples, the illuminator(s) 134R include a plurality of illuminators 134R (e.g., two, three, four, or any number greater than four) that are positioned around the second infrared camera 132R. For example, the reflective marker(s) 152, when illuminated with an infrared light source (e.g., the illuminator(s) 134R), reflects back the infrared light 140 in the same direction. The second infrared camera 132R receives the reflected infrared light 140 and may detect the 2D positions 118R of the reflective marker(s) 152, e.g., the 2D position 118R of the reflective marker 152-1, the 2D position 118R of the reflective marker 152-2, and the 2D position 118R of the reflective marker 152-3. The 2D position 118R includes a 2D coordinate (e.g., x, y) of a respective reflective marker 152 in a camera plane 105R associated with the second infrared camera 132R.

The computing device 101 includes a controller 106. In some examples, the controller 106 is one of the processors 102. In some examples, the controller 106 is a microcontroller. The controller 106 is connected to the first infrared camera 132L and the second infrared camera 132R. In some examples, the controller 106 is connected to each of the first infrared camera 132L and the second infrared camera 132R via an I2C connection (e.g., an I2C connection is an inter-integrated circuit protocol where data is transferred bit by bit along a single wire).

Referring to FIG. 1B, the controller 106 includes a stereo depth estimator 120 configured to estimate 3D positions 122 of the reflective marker(s) 152 based on the 2D positions 118L detected by the first infrared camera 132L and the 2D positions 118R detected by the second infrared camera 132R.

The details of the stereo depth estimator 120 are depicted in FIG. 1C. The stereo depth estimator 120 may receive the 2D positions 118L and the 2D positions 118R. Referring to FIG. 1C, the 2D positions 118L are from the perspective of a camera plane 105L of the first infrared camera 132L. The 2D positions 118L may include a 2D position 118L-1 of the reflective marker 152-1, a 2D position 118L-2 of the reflective marker 152-2, and a 2D position 118L-3 of the reflective marker 152-3. The 2D positions 118R are from the perspective of a camera plane 105R of the second infrared camera 132R. The 2D positions 118R may include a 2D position 118R-1 of the reflective marker 152-1, a 2D position 118R-2 of the reflective marker 152-2, and a 2D position 118R-3 of the reflective marker 152-3.

The stereo depth estimator 120 may match the 2D positions 118L with the 2D positions 118R (or vice versa). For example, for each reflective marker 152, the stereo depth estimator 120 may identify a 2D position 118L and a corresponding 2D position 118R. As such, each reflective marker 152 may be associated with two 2D positions, e.g., one from the first infrared camera 132L and one from the second infrared camera 132R. In some examples, for each reflective marker 152, the stereo depth estimator 120 may receive both 2D coordinates (e.g., 2D position 118L, 2D position 118R) and the size of the reflective marker 152. Since each reflective marker 152 has a distinct size (e.g., different diameter), the size parameter of each detected reflective marker 152 may assist with matching 2D positions.

The stereo depth estimator 120 may identify a first set of a 2D position 118L-1 and a 2D position 118R-1 as corresponding to the reflective marker 152-1. The stereo depth estimator 120 may identify a second set of a 2D position 118L-2 and a 2D position 118R-2 as corresponding to the reflective marker 152-2. The stereo depth estimator 120 may identify a third set of a 2D position 118L-3 and a 2D position 118R-3 as corresponding to the reflective marker 152-3.

For each reflective marker 152, the stereo depth estimator 120 may execute a depth estimation algorithm configured to estimate (e.g., triangulate) the 3D position 122 (e.g., x, y, z) of a respective reflective marker 152 based on the 2D position 118L received from the first infrared camera 132L and the 2D position 118R received from the second infrared camera 132R. The stereo depth estimator 120 includes a disparity estimation unit 107 configured to compute a disparity between the 2D position 118L and the 2D position 118R for a respective reflective marker 152. The disparity estimation unit 107 may compute the disparity as the sum of the absolute difference between the 2D position 118L (coordinates x_{left} and y_{left}) and the 2D position 118R (coordinates X_{right} and y_{right}), as follows:

d=∥x_{left}−x_{right}∥+∥y_{left}−y_{right}∥ Eq. (1):

The stereo depth estimator 120 includes a depth computation unit 109 configured to compute the 3D position 122 for each reflective marker 152 based on a projection equation, as follows:

$$\begin{matrix}[ \begin{matrix}1 & 0 & 0 & 0 \\ 0 & 1 & 0 & 0 \\ 0 & 0 & 1 / f & 0\end{matrix} ] [ \begin{matrix}x \\ y \\ z \\ 1\end{matrix} ] = [ \begin{matrix}x \\ y \\ z / f\end{matrix} ] & Eq . ( 2 ) \\ z = f * B / D & Eq . ( 3 )\end{matrix}$$

The parameter f is the focal length (in pixels) obtained from calibration data 110 generated by a stereo camera calibrator 108 (further described below). The parameter B is the baseline separation (e.g., the distance) between the first infrared camera 132L and the second infrared camera 132R (e.g., in centimeters). The parameter d is the disparity (in pixels) that is computed by the disparity estimation unit 107. In some examples, the parameter B is stored as part of the calibration data 110. The depth computation unit 109 may obtain the focal length f and the parameter B from the calibration data 110 (and/or a memory device 104) and the disparity from the disparity estimation unit 107. The depth computation unit 109 may input the focal length f, the parameter B, and the disparity to the projection equation to compute the 3D position 122 for each reflective marker 152. In some examples, using equations Eq. (1) through (3), the depth computation unit 109 may project (e.g., re-project) the disparity back to a real-world 3D point (e.g., x, y, z).

In some examples, the stereo depth estimator 120 includes a filtering unit 103 configured to filter the depth values (e.g., z points) of the 3D positions 122 using a filter (e.g., a Kalman filter). In some examples, the stereo depth estimation algorithm described herein may be implemented on a smartphone or lightweight AR smart glasses in which the user is relatively close to the infrared cameras, which can cause unpredictable jitter (thereby introducing noise/errors into the 3D position 122). In order to reduce the effect of jitter on the 3D positions 122, the filtering unit 103 may filter the depth values (e.g., the raw depth values) with a Kalman filter. The filtering unit 103 is configured to implement a Kalman filter by recursively predicting the next z-value state and correcting the z-value state with only the present z-value and a previously measured estimate of the z-value state. FIG. 1D depicts the 3D positions 122 before and after Kalman filtering.

Generally, Kalman filtering may be an algorithm that estimates the state of a dynamic system from a series of noisy measurements. The filtering unit 103 may implement a Kalman filter by recursively predicting the next z-value state and updating the z-value state with the present z-value and a previously measured estimate of the z-value state. In some examples, the notation of a dynamic system with incomplete or nosy measurements may be defined using the following equations:

xₜ=Axₜ₋₁+Buₜ+Wₜ Eq. (4):

zₜ=Hxₜ+vₜ Eq. (5):

In some examples, the linear Kalman filter predictions may be defined using the following equations:

xₜ=Axₜ₋₁+Buₜ+wₜ Eq. (6):

Pₜ=APₜ₋₁A^{T}+Qₜ Eq. (7):

In some examples, the correction equations may be defined using the following equations:

Kₜ=PₜH^{T}(HPₜH^{T}+Rₖ)⁻¹ Eq. (8):

xₜ=xₜ+Kₜ(Zₜ−Hxₜ) Eq. (9):

Pₜ=(1−KₜH)Pₜ Eq. (10):

At time t, xₜ is the state variable, xₜ0 is the estimate, zₜ is the observation of the state xₜ, Pₜ is the estimated state error covariance, Pₜ is the state error covariance, A is the state-transition model, B is the control-input model, H is the observation/measurement model, Kₜ is the Kalman gain, Qₜ is the covariance of process nose, Rₖ is the covariance of observation noise, wₜ is the process noise wₜ˜N(0, Qₜ), vₖ is the observation noise vₖ˜N(0, Rₖ) and uₜ is the control vector.

For depth/Z-value stabilization/smoothing, the object tracker 100 may include a static sensor (e.g., the first IR camera 132L and the second IR camera 132R) and a moving component (e.g., the physical component 150). In some examples, H and A may be set to one since a scalar correspondence may exist between the Z-value measurements, and, in some examples, the depth may not be higher than the noise amplitude between two consecutive frames (at t and t−1). B=0 is set since the first IR camera 132L and the second IR camera 132R may be fixed. Rₖ=σₖ² is the covariance of the measurement noise. In some examples, the Kalman filter equations become as follows:

xₜ=xₜ₋₁ Eq. (11):

Pₜ=Pₜ₋₁ Eq. (12):

For correction, the following equations are used:

Kₜ=Pₜ(Pₜ+Rₖ)⁻¹ Eq. (13):

xₜ=xₜ+Kₜ(Zₜ−xₜ) Eq. (14):

Pₜ=(1−Kₜ)ₜ Eq. (15):

The filtering unit 103 may execute the Kalman filter to further smooth the depth values of the 3D positions 122, which, in some examples, may assume that the depth of the physical component 150 changes slightly between two successive frames.

Referring back to FIG. 1A, the controller 106 includes an orientation estimator 124 configured to compute an orientation 126 of the physical component 150 based on the 3D positions 122 computed by the stereo depth estimator 120. In some examples, the orientation 126 includes a 6DoF orientation 128. However, the orientation 126 may also include a 3DoF orientation, 4DoF orientation, or a 5DoF orientation.

The orientation estimator 124 may compute the orientation 126 based on one or more of the 3D positions 122 and positioning information 149 about the reflective marker(s) 152 in the physical component 150. In some examples, the positioning information 149 indicates the marker positions in the physical component 150. The positioning information 149 may include information about a position (e.g., physical position) of the reflective marker(s) 152 in the physical component 150. The positioning information 149 indicates the layout of a reflective marker 152 in a coordinate frame (e.g., a coordinate space) of the physical component 150. In some examples, the positioning information 149 includes the coordinates of one or more reflective markers 152 in a coordinate frame. In some examples, the positioning information 149 may indicate the coordinates (e.g., x, y, and z coordinates) of one or more reflective markers 152 in a coordinate frame (e.g., reflective marker 152-1 is positioned at (0, 0, 0), reflective marker 152-2 is positioned 152-2 at (0, 0, 2), reflective marker 153-3 is positioned at (0, 0.5, 1)). The positioning information 149 may indicate the distance between reflective marker(s) 152 in a coordinate frame. In some examples, the positioning information 149 may indicate the position of a reflective marker 152 from one or more other elements or components of the physical component 150. In some examples, the positioning information 149 includes a triangular layout (e.g., geometry) of the reflective markers 152. In some examples, the reflective markers 152 form an asymmetrical triangle with unique distances (e.g., side lengths) between the corners.

The orientation estimator 124 may compute the rotation and translation data (e.g., the rotation (R) and translation (t) matrices) from the three marker positions (real-world coordinate frame) (e.g., the 3D positions 122) and compare them with the object markers (coordinate frame of the physical component 150) (e.g., the positioning information 149).

For every marker pair, if the following equation is satisfied, the orientation estimator 124 may determine the transformation parameters as follows:

∥yᵢ−(Rxᵢ+t)∥<tolerance,∀i∈{1, 2, 3} Eq. (16):

The parameter yᵢ refers to the 3D position 122 of iₜₕ marker and xᵢ refers to the position of the iₜₕ object marker (e.g., the positioning information 149).

In some examples, referring to FIG. 1B, the controller 106 includes an occlusion corrector 112 configured to compute, using one or more neural networks 114, a 3D position 122 for one or more occluded (e.g., missing, not detected) reflective markers 152. For example, one or more reflected markers 152 may be hidden (e.g., in some examples, by the hand of the user (or other objects)), and therefore, the 2D position 118R and/or the 2D position 118L for a respective reflective marker 152 may not be detected. In other words, all three retroreflective markers 152 may not be present in each camera view (e.g., camera plane 105L, camera plane 105R) to estimate the orientation 126 (e.g., 6DoF orientation 128) of the physical component 150. Without the occlusion corrector 112, if a single marker position is missing due to occlusion (e.g., hand occlusion), the stereo depth estimator 120 may not be able to estimate the orientation 126 (e.g., 6DoF orientation 128) of the physical component 150.

However, the occlusion corrector 112 may implement a neural network-based occlusion correction procedure configured to estimate the 3D position 122 of one or more occluded retroreflective markers 152. FIG. 1E illustrates an example of the controller 106 with the occlusion corrector 112. For a single missing reflective marker 152, the occlusion corrector 112 may include a neural network 114-1 configured to compute a 3D position 122a of a missing reflective marker 152. The 3D position 122a is one of the 3D positions 122 and corresponds to a reflective marker 152 in which a 2D position 118L and/or a 2D position 118R is not detected by the first IR camera 132L and/or the second IR camera 132R. For two or more missing reflective markers 152, the occlusion corrector 112 may include a neural network 114-2 configured to compute a 3D position 122b of two (or more) missing (e.g., not detected) reflective markers 152.

As shown in FIG. 1E, in operation 121, the controller 106 determines whether there are any missing reflective markers 152 in one or more observed frames. For example, if the 2D position 118L and/or the 2D position 118R of a respective reflective marker 152 is not detected in a camera plane 105R or a camera plane 105L, the controller 106 determines that the respective reflect marker 152 is missing (e.g., occluded). On the other hand, if the 2D positions 118L and the 2D positions 118R for all reflected markers 152 are detected, the controller 106 determines that no reflective markers 152 are missing (e.g., occluded). If No, in operation 123, the stereo depth estimator 120 computes the 3D positions 122 for the reflective markers 152 on the physical component 150 in the manner as described above. In operation 133, the orientation estimator 124 estimates the orientation 126 (e.g., 6DoF orientation 128) as described above.

If yes, in operation 127, the controller 106 determines how many reflective markers 152 are missing. If one reflective marker 152 is missing, in operation 129, the occlusion corrector 112 uses the neural network 114-1 to estimate the 3D position 122a for the missing reflective marker 152.

The neural network 114-1 includes an input layer 162, a first hidden layer 164, a second hidden layer 166, and an output layer 168. In some examples, the first hidden layer 164 includes one hundred and twenty eight neurons. In some examples, the second hidden layer 166 includes sixty-four neurons. In some examples, the output layer 168 includes three neurons. In some examples, each of the first hidden layer 164 and the second hidden layer 166 uses a sigmoid activation function. In some examples, the output layer 168 uses a linear activation function. As an input 160 to the input layer 162, the neural network 114-1 receives the 3D positions 122 of the two observed reflective markers, e.g., reflective marker 152-1, and reflective marker 152-2. The input 160 also includes the identifier of the reflective marker 152-1 and the reflective marker 152-2. The identifier of the reflective marker 152-1 may be the size of the reflective marker 152-1. The identifier of the reflective marker 152-2 may be the size of the reflective marker 152-2. The output of the neural network 114-1 is the 3D position 122a of the missing reflective marker 152-3. In operation 133, the orientation estimator 124 uses the 3D positions 122 (including the 3D position 122a) to compute the orientation 126.

If two or more reflective markers 152 are missing, in operation 131, the occlusion corrector 112 uses the neural network 114-2 to estimate the 3D position 122b of the two missing reflective markers, e.g., reflective marker 152-2 and reflective marker 152-3. The neural network 114-2 includes an input layer 161, a first hidden layer 163, a second hidden layer 165, and an output layer 167. In some examples, the first hidden layer 163 includes two hundred and fifty-six neurons. In some examples, the second hidden layer 165 includes one hundred and twenty-eight neurons. In some examples, the output layer 167 includes six neurons. Each of the first hidden layer 163 and the second hidden layer 165 may use a sigmoid activation function. The output layer 167 may use a linear activation function. As an input 159 to the input layer 161, the neural network 114-2 receives the 3D positions 122 of the observed reflective marker, e.g., reflective marker 152-1. The input 159 also includes the identifier for the observed reflective marker. The identifier for the observed reflective marker may be the size of the reflective marker. Further, the input 159 may include the 3D positions for the first through third reflective marker (152-1 to 152-3) for a previous time interval (e.g., the previous five seconds). The output of the neural network 114-2 is the 3D position 122b of the missing reflective marker 152-2 and the missing reflective marker 152-3. In operation 133, the orientation estimator 124 uses the 3D positions 122 (including the 3D positions 122b) to compute the orientation 126.

The neural network 114-1 and/or the neural network 114-2 may be trained using training data (e.g., real-time data) from a plurality of users. To collect the training data, a user may wear the computing device 101 and randomly wave the physical component 150 in mid-air for a period of time (e.g., ten minutes). The 3D positions 122 estimated by the controller 106 may be sent to a computer. The training data may be used to train the neural network 114-1 and/or the neural network 114-2 and data from other users may be used to test the accuracy of the models. In some examples, for training a neural network 114-1, one of the reflective markers 152 in each 3D coordinate was randomly discarded, and the remaining markers were passed as an input to the neural network 114-1. The input and output pairs may be the 3D coordinates of the two reflective markers along with their marker identifiers and the corresponding 3D coordinate of the discarded marker. During testing, the neural network 114-1 had relatively high accuracies (e.g., 98.2%, 98.6%, and 97.4%) in predicting the x, y, and z coordinates respectively of the occluded/dropped marker. For training the neural network 114-2 for handling two marker occlusion, two of the reflective markers 152 in each 3D coordinate were randomly discarded and the other marker was passed as an input to the neural network 114-2. The input and output pairs may be 3D coordinates of the reflective marker along with its marker identifier plus 3D coordinates of the three markers from the image frames from a previous period of time (e.g., five seconds). During testing, the neural network 114-2 had relatively high accuracies (e.g., 95.2%, 95.6%, and 94.2%) in predicting x, y, z coordinates respectively of the occluded/dropped markers. In some examples, the neural network 114-1 or the neural network 114-2 may be trained offline using a software library for machine learning and artificial intelligence (e.g., TensorFlow) and the trained models (e.g., neural network 114-1, neural network 114-2) were deployed on the controller 106 to perform online neural network inference.

Referring back to FIG. 1A, the controller 106 includes a stereo camera calibrator 108 configured to execute a calibration algorithm to obtain calibration data 110, some of which are used as part of the stereo depth estimator 120. During the calibration process, the user may move the physical component 150 (e.g., in mid-air) for a threshold period of time (e.g., thirty seconds), as the controller 106 detects (e.g., continuously detects) the 2D positions 118L and the 2D positions 118R of the reflective markers 152 (A, B,C) of the physical component 150.

FIG. 1G illustrates a camera model 155 of the first infrared camera 132L and the second infrared camera 132R. The camera model 155 may be a pinhole camera model of the hardware of the object tracker 100. The 2D position 118 and the 3D position 122 are represented as [x,y]^{T} and [X,Y,Z]^{T} respectively. The homogeneous vectors of the 2D and 3D positions (e.g., 118 and 122) are represented as [x,y, 1]^{T} and [X,Y, Z, 1]^{T} respectively. The perspective projection of the 2D coordinates to its corresponding 3D points is represented as:

$${s [ x , y , 1 ]}^{T} = K \vert R \vert {\vert t \vert [ X , Y , Z , 1 ]}^{T} and k = \begin{matrix}α & γ & {x}_{0} \\ 0 & β & {y}_{0} \\ 0 & 0 & 1\end{matrix} \qquad Eq . ( 17 )$$

The parameter s is the scale factor and P=k|R|t is the camera matrix with R|t being the rotation and translation matrices (e.g., extrinsic matrix) to transform the camera coordinates to the real-world coordinates. The parameter K is the intrinsic matrix of the camera and [x₀, y₉] is the principal point. The parameters a, b, c represent the three reflection marker locations of the physical component 150 that is captured by the infrared cameras (e.g., the first IR camera 132L, the second IR camera 132R). Give the image points {aᵢⱼ, bᵢⱼ, cᵢⱼ|ⱼ=1,2, . . . n, i=L, R} of the physical component 150 from the left and right cameras (e.g., the first IR camera 132L, the second IR camera 132R) under the i^{th} image frame. The calibration algorithm is configured to compute the metric projection matrix under the left camera coordinate system as follows:

P_{L}^{(e)}=K_{L}|R_{L}t_{L} and P_{R}^{(e)}=K_{R}R_{R}t_{R} Eq. (18):

The stereo camera calibrator 108 may linearly obtain the left and right camera matrices. First, the stereo camera calibrator 108 may compute the vanishing points of the reflective markers 152. Then, the stereo camera calibrator 108 may compute the infinite homographies between the first IR camera 132L and the second IR camera 132R. Using the infinite homographies, the stereo camera calibrator 108 can compute the affine projection matrix and the metric projection matrix. In contrast to some conventional calibration methods, the calibration algorithm does not require a calibrated base camera and the calibration can be executed automatically without a calibration board or object.

Referring to FIG. 1F, in operation 111, the stereo camera calibrator 108 executes affine calibration using the 2D positions 118L and the 2D positions 118R of the reflective markers 152 to compute an affine camera matrix. An affine camera matrix is a matrix (e.g., 3×3 matrix) that describes the transformation of 3D points to 2D image points. As the user waves the physical component 150 (e.g., in mid-air) for a threshold period (e.g., thirty seconds), the correspondence of the image points {aᵢⱼ,bᵢⱼ,cᵢⱼ|j=1,2, . . . n, i=L, R} can be established by identifying the unique marker size for each reflective marker 152 in the physical component 150. Since the geometry of the physical component 150 is known, the stereo camera calibrator 108 may obtain the vanishing points (v_{i,j}) of the line L_{ABC} in both the first IR camera 132L and the second IR camera 132R. The ratio of the marker points A, B, and C is given by,

$$simple ( {A}_{j} , {B}_{j} , {C}_{j} ) = \frac{{d}_{1}}{{d}_{2}} \qquad Eq . ( 19 )$$

d₁=∥A−C∥ and d₂=∥B−C∥. The cross ratio of the points {Aⱼ, Bⱼ,Cⱼ,V_{j∞}} is also d₂/d₁ where V_{j∞} is the infinite point of line ABC. Since the perspective transformation preserves the cross ratio, the stereo camera calibrator 108 may obtain the vanishing points from the linear constraints on vᵢⱼ as follows:

$$cross ( {A}_{j} , {B}_{j} , {C}_{j} , {V}_{ij} ) = \frac{{d}_{1}}{{d}_{2}} \qquad Eq . ( 20 )$$

The infinite homograph between the left and right cameras satisfies the below equations:

H_{R∞}v_{Lj}=λ_{Rj}v_{Rj,(j=1,2, . . . n)} Eq. (21):

From the above equation, the unknown scale factor λ_{Rj} can be eliminated to obtain:

[v_{Rj}]×H_{R∞}v_{Rj}=0,(j=1,2, . . . n) Eq. (22):

The stereo camera calibrator 108 can solve the linear equations in Eq. (22) to determine the infinite homographies. With the homographies and the image points, the stereo camera calibrator 108 can compute the projective reconstruction of the 2D points and the camera using the technique of projective reconstruction with planes. The stereo camera calibrator 108 computes the affine camera matrices based on the following equations:

P_{L}^{(a)}=[H_{L∞}|e_{L}] and P_{R}^{(a)}=[H_{R∞}|e_{R}] Eq. (23)

The affine reconstruction of the 2D marker locations may be {Aⱼ^{(a)}, Bⱼ^{(a)}, Cⱼ^{(a)}}.

In operation 113, the stereo camera calibrator 108 executes metric calibration to compute the metric projection matrices using the affine projection matrix computed in operation 111. A metric projection matrix for stereo camera calibration is a matrix that describes the relationship between 3D points in the world and the corresponding 2D image points in the left and right stereo images. A metric projection matrix may be used to calibrate stereo cameras. The stereo camera calibrator 108 may compute the metric projection matrices based on the following equation:

Pᵢ^{(e)}=Pᵢ^{(a)}diag(K₀, 1), (i=L,R) Eq. (24):

The metric reconstruction of the image points may satisfy the below equation:

Aⱼ^{(e)}=K₀⁻¹Aⱼ^{(a)}, Bⱼ^{(e)}=K₀⁻¹Bⱼ^{(a)}; Cⱼ^{(e)}=K₀⁻¹Cⱼ^{(a)}, j=(1,2, . . . , n) Eq. (25):

K₀ is the intrinsic parameter of the first IR camera 132L. Since the stereo camera calibrator 108 already obtained ∥Aⱼ^{(e)}−Cⱼ^{(e)}∥=d₁; ∥Bⱼ^{(e)}−Cⱼ^{(e)}∥=d₂, the stereo camera calibrator 108 may obtain the linear constraints for obtaining K₀ from Eq. (25) as follows:

(Cⱼ^{(e)}−Aⱼ^{(a)})^{T}ω(Cⱼ^{(a)}−Aⱼ^{(a)})=d₁²; (Cⱼ^{(a)}−Bⱼ^{(a)})^{T}ω(Cⱼ^{(a)}−Bⱼ^{(a)})=d₂², where ω=K₀₍^{-T}K₀⁻¹. Eq. (26):

The stereo camera calibrator 108 may obtain ω from solving Eq. (26) and the stereo camera calibrator 108 may obtain K₀ from the Cholesky decomposition of ω¹. From K₀(K_{L}), the stereo camera calibrator 108 may obtain the intrinsic parameters K_{R}, the rotation matrices, and the translation matrices using QR decomposition of the metric projection matrix. In operation 115, the stereo camera calibrator 108 is configured to bundle the adjustment, e.g., generate the calibration data 110 (which is stored in a memory device 104).

The object tracker 100 may enable a wide variety of applications, including 2D or 3D drawing, 3D user interfaces (and interactions with 3D user interfaces), real-time measurements, and home appliance control in an accurate manner that is less computational expensive than some conventional approaches. In some examples, one or more reflective markers 152 may be attached to distinct parts of a room or physical objects to provide smart control of devices. In some examples, reflective markers 152 can be attached to real-world objects to provide an interface (e.g., menu items) for smart home control. In some examples, the object tracker 100 may communicate with an application (e.g., a smart control application) operating on the user's headset or operating on the user's device that is connected to the user's headset. In some examples, interaction with the reflective markers 152 may cause the user to control a device.

In some examples, the physical component 150 includes an arrangement of reflective markers 152 (e.g., two or more reflective markers 152), and the physical component 150 is coupled to a device (e.g., a microwave). In some examples, the reflective markers 152 are embedded into the device. In some examples, the reflective markers 152 are arranged in a keypad format (or in a row, or in a column, or another type of arrangement). In some examples, each key of the keypad includes a reflective marker 152 (e.g., reflective tape). When a user's finger presses the key (e.g., a particular reflective marker 152), the object tracker 100 detects that the reflective marker 152 is occluded. In some examples, in response to the reflective marker 152 being detected as occluded, an application may trigger an action associated with a device (e.g., start a microwave). In some examples, the object tracker 100 may identify a keypress occlusion (e.g., by the finger) by selecting the top-most occlusion on a partially occluded keypad. In some examples, the reflective markers 152 (e.g., the keys) may be configured as switches or controls for smart appliances control such as activating or deactivating lights or fans or as a messaging interface on real-world objects.

In some examples, the physical component 150 is a slider attached with a reflective marker 152. Depending on the slider position, the object tracker 100 may detect the orientation 126 (e.g., 3D coordinates) of the reflective marker 152 on the slider to identify the slider position and appropriate functions for the device can be configured for each of the slider positions. In some examples, the physical component 150 with one or more reflective markers 152 may be attached to a microwave or oven door to detect opening and closing, which may trigger smart appliance control. In some examples, using the reflective markers 152, the object tracker 100 may detect the opening and closing action of a door, which can be used to track when food is inserted. An application that uses the object tracker 100 may trigger a notification to the user's device if the door has not been opened after a threshold period of time. In some examples, reflective markers 152 may be attached to doors, which can be used to detect entry of a user to a room to trigger application control such as activating or deactivating lights, fans, etc.

In some examples, the object tracker 100 may operate with a 2D or 3D drawing application, which can transform a flat surface into a 2D digital drawing or writing canvas by leveraging the distance between the physical component 150 (e.g., a stylus) and the closest surface. In some examples, the object tracker 100 may execute on a head-mounted display device, and the head-mounted display device may operate with an application executing on a user's device (e.g., laptop, smartphone, desktop, etc.) in which the user writes on the flat surface of a table with the physical component 150 and the application executing on the user's device may visualize the 6DoF position (e.g., the orientation 126) of the physical component 150.

In some examples, the object tracker 100 may operate with a 3D drawing application, which may enable a user to digitally draw in free 3D space. The object tracker 100 may provide absolute 6DoF position tracking of the physical component 150 (e.g., a stylus), thereby allowing the user to paint or write at different depths. In some examples, the user can perform mid-air drawings and the application may visualize the strokes made by the physical component 150 with depth represented by a depth colormap. In some examples, the 3D drawing application may provide volumetric 3D sculpting for drawing 3D cartoons and objects.

In some examples, the object tracker 100 may operate with a VR/AR application that enables interaction with a 3D user interface. For example, 3D input (e.g., the orientation 126) can be used to control 3D UI elements (e.g., 3D buttons and other spatial elements such as sliders and dials). In some examples, the AR/VR application may display UI elements (e.g., buttons, sliders, and dropdowns) at different depths in a virtual room and the user may use the physical component 150 to interact with a 3D user interface. In some examples, the object tracker 100 may use the rate of change in the depth to identify a button press or select a slider/dropdown using the physical component 150. In some examples, the object tracker 100 may enable an application to determine the minimum size of 3D UI elements based on their desired depth placements, which may reduce (or eliminate) stylus interaction failures.

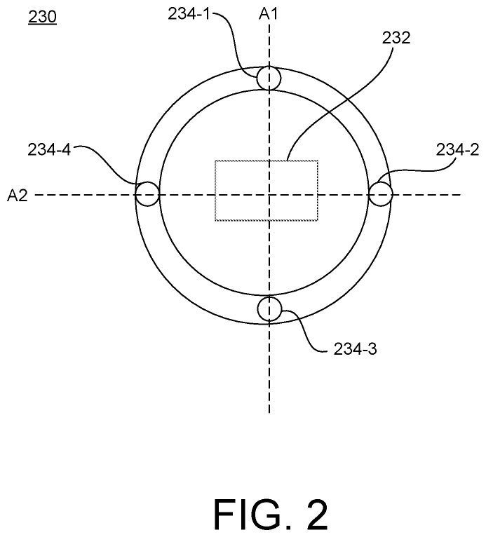

FIG. 2 illustrates an IR camera unit 230 according to an aspect. The IR camera unit 230 may be an example of the IR camera unit 130L or the IR camera unit 130R of FIGS. 1A through 1G and may include any of the details discussed with reference to FIGS. 1A through 1G. The IR camera unit 230 includes an infrared camera 232 and a plurality of illuminators such as illuminator 234-1, illuminator 234-2, illuminator 234-3, and illuminator 234-4. In some examples, the infrared camera 232 is one of a stereo pair of infrared cameras. In some examples, the infrared camera 232 is an infrared blob tracking camera. The illuminators may include infrared LED emitters.

Although four illuminators are depicted in FIG. 2, the IR camera unit 230 may include any number of illuminators such as one, two, or any number greater than four. The illuminators may form a circular array in which the illuminators are positioned around the infrared camera. In some examples, the illuminators are spaced apart at ninety degrees. If additional illuminators are used, the illuminators may be spaced apart at forty-five degrees or twenty-two and one-half degrees, etc. In some examples, the illuminator 234-1 and the illuminator 234-3 are aligned along an axis A1, and the illuminator 234-2 and the illuminator 234-4 are aligned along an axis A2. The axis A1 and axis A2 are perpendicular to each other. The infrared camera 232 may be positioned at an intersection of the axis A1 and the axis A2.

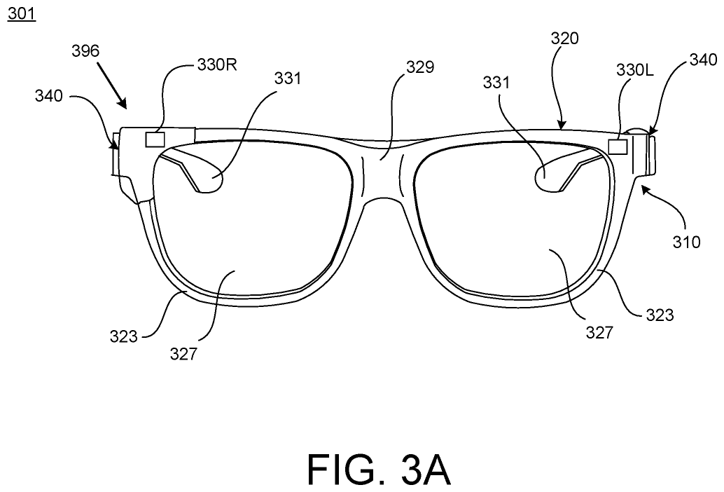

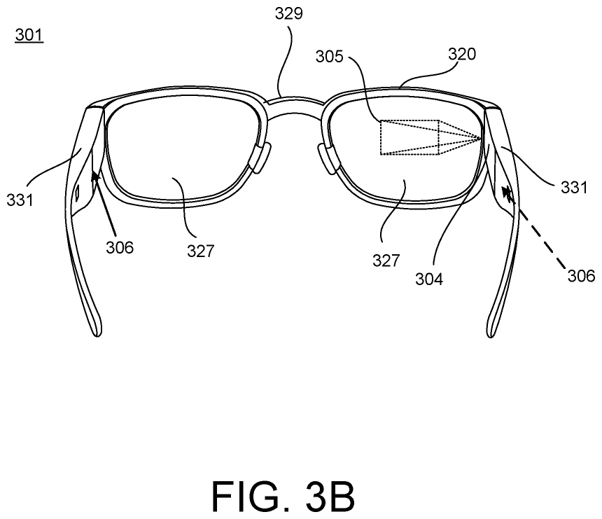

FIGS. 3A and 3B illustrate an example of a head-mounted wearable device 301 according to an aspect. The head-mounted wearable device 301 may be an example of the computing device 101 of FIGS. 1A through 1G and may include any of the details discussed with reference to those figures. The head-mounted wearable device 301 includes smart glasses 396 or augmented reality glasses, including display capability, computing/processing capability, and object tracking capability with a physical component (e.g., the physical component 150 of FIGS. 1 through 1G). FIG. 3A is a front view of the head-mounted wearable device 301, and FIG. 3B is a rear view of the head-mounted wearable device 301.

The head-mounted wearable device 301 includes a frame 310. The frame 310 includes a front frame portion 320, and a pair of arm portions 331 rotatably coupled to the front frame portion 320 by respective hinge portions 340. The front frame portion 320 includes rim portions 323 surrounding respective optical portions in the form of lenses 327, with a bridge portion 329 connecting the rim portions 323. The arm portions 331 are coupled, for example, pivotably or rotatably coupled, to the front frame portion 320 at peripheral portions of the respective rim portions 323. In some examples, the lenses 327 are corrective/prescription lenses. In some examples, the lenses 327 are an optical material including glass and/or plastic portions that do not necessarily incorporate corrective/prescription parameters.

The front frame portion 320 includes an IR camera unit 330L. The IR camera unit 330L may be an example of the IR camera unit 130L of FIGS. 1A through 1G and/or the IR camera unit 230 of FIG. 2 and may include any of the details discussed with reference to those figures. For example, the IR camera unit 330L may include a first infrared camera (e.g., a left camera) with an array of illuminators.

The front frame portion 320 includes an IR camera unit 330R. The IR camera unit 330R may be an example of the IR camera unit 130R of FIGS. 1A through 1G and/or the IR camera unit 230 of FIG. 2 and may include any of the details discussed with reference to those figures. For example, the IR camera unit 330R may include a second infrared camera (e.g., a right camera) with an array of illuminators. A controller 306 may be provided in one of the two arm portions 331, as shown in FIG. 3B. The controller 306 may be an example of the controller 106 of FIGS. 1A through 1G and may include any of the details discussed with reference to those figures.

In some examples, the head-mounted wearable device 301 includes a display device 304 configured to output visual content, for example, at an output coupler 305, so that the visual content is visible to the user. The display device 304 may be provided in one of the two arm portions 331. In some examples, a display device 304 may be provided in each of the two arm portions 331 to provide for binocular output of content. In some examples, the display device 304 may be a see through near eye display. In some examples, the display device 304 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 327, next to content (for example, digital images, user interface elements, virtual content, and the like) output by the display device 304. In some implementations, waveguide optics may be used to depict content on the display device 304.

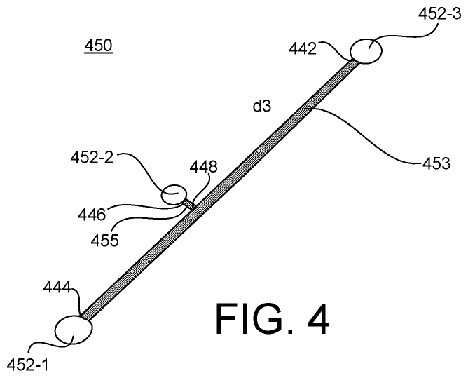

FIG. 4 illustrates an example of a physical component 450 according to an aspect. The physical component 450 may be an example of the physical component 150 of FIGS. 1A through 1G and may include any of the details discussed with reference to those figures. In some examples, the physical component 450 is a stylus. In some examples, a user may use the stylus to create 2D or 3D drawings, take notes, operate 3D user interfaces, interact with real and/or virtual objects, and/or detect or control the use or operation of real world objects.

The physical component 450 includes an elongated member 453. The elongated member 453 may include a tubular member having a diameter. The physical component 450 includes a reflective sphere 452-1 positioned at (and coupled to) an end portion 444 of the elongated member 453 and a reflective sphere 452-3 positioned at (and coupled to) an end portion 442 of the elongated member 453. In some examples, the distance between the end portion 442 and the end portion 444 defines a length of the elongated member 453. In some examples, the length of the elongated member 453 is fifteen centimeters.

The physical component 450 includes a reflective sphere 452-2 positioned at (and coupled to) a location between the end portion 444 and the end portion 442. In some examples, the reflective sphere 452-2 is positioned at a location that is closer to one of the reflective sphere 452-1 or reflective sphere 452-3. In some examples, the physical component 450 includes an arm portion 455 that connects the reflective sphere 452-2 to the elongated member 453. In some examples, the arm portion 455 is a tubular member having a diameter. The arm portion 455 has an end portion 446 connected to the reflective sphere 452-2 and an end portion 448 connected to the elongated member 453. In some examples, the distance between the end portion 446 and the end portion 448 defines the length of the arm portion 455. The length of the arm portion 455 may be perpendicular to the length of the elongated member 453.

The size (e.g., diameter) of each of the reflective sphere 452-1, the reflective sphere 452-2, and the reflective sphere 452-3 may be different. The size of the reflective sphere 452-1 may be greater than the size of the reflective sphere 452-3, and the size of the reflective sphere 452-3 may be greater than the size of the reflective sphere 452-2. In some examples, the size of the reflective sphere 452-1 is ten millimeters. In some examples, the size of the reflective sphere 452-2 is six millimeters. In some examples, the size of the reflective sphere 452-3 is eight millimeters. In some examples, the distance between any two reflective spheres is different. The distance (D1) between the reflective sphere 452-1 and the reflective sphere 452-3 is greater than the distance (D3) between the reflective sphere 452-3 and the reflective sphere 452-2, and the distance (D3) is greater than the distance (D2) between the reflective sphere 452-2 and the reflective sphere 452-1. In some examples, each of the reflective sphere 452-1, the reflective sphere 452-2, and the reflective sphere 452-3 has the shape of an obtuse triangle, which may assist with estimating an orientation (e.g., a 6DoF orientation).

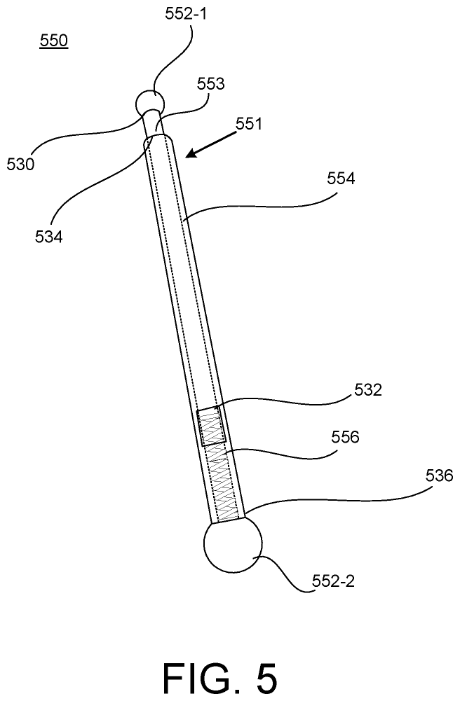

FIG. 5 illustrates an example of a physical component 550 according to another aspect. The physical component 550 may be an example of the physical component 150 of FIGS. 1A through 1G and may include any of the details discussed with reference to those figures. In some examples, the physical component 550 may be considered a pen structure 551 that a user can use to write or draw on a 2D surface.

The pen structure 551 is configured to enable a first reflective marker (e.g., reflective sphere 552-1) to move with respect to a second reflective marker (e.g., reflective sphere 552-2) when force is applied to an end of the pen structure 551 (e.g., when the user presses the pen structure against a surface). When the distance between the reflective sphere 552-1 and the reflective sphere 552-2 is reduced (e.g., reduced to below a threshold level), the controller (e.g., the controller 106 of FIGS. 1A to 1G) may activate tracking of the physical component 550 (e.g., to create a 2D drawing).

The physical component 550 includes an inner elongated member 553 and an outer elongated member 554. The inner elongated member 553 may be a tubular member with a diameter that is less than a diameter of the outer elongated member 554. The inner elongated member 553 is at least partially disposed within a cavity of the outer elongated member 554. The inner elongated member 553 includes an end portion 530 coupled to the reflective sphere 552-1, and an end portion 532 coupled to a bias member 556. In some examples, the bias member 556 includes a spring. The bias member 556 is disposed within the outer elongated member 554.

The distance between the end portion 530 and the end portion 532 may define the length of the inner elongated member 553. The outer elongated member 554 includes an end portion 534 and an end portion 536. The distance between the end portion 534 and the end portion 536 may define the length of the outer elongated member 554. The end portion 536 is connected to the reflective sphere 552-2. The size (e.g., diameter) of the reflective sphere 552-1 is different from the size (e.g., diameter) of the reflective sphere 552-2. In some examples, the size of the reflective sphere 552-1 is greater than the size of the reflective sphere 552-2.

The bias member 556 may bias the reflective sphere 552-1 at a distance away from the end portion 534 of the inner elongated member 553. In the uncompressed state, the reflective sphere 552-1 may be separated from the reflective sphere 552-2 by a first distance (e.g., one hundred and ninety-five millimeters). When the user presses the reflective sphere 552-1 on a surface, the bias member 556 may contract (e.g., compress) causing the distance between the reflective sphere 552-1 and the reflective sphere 552-2 to be shorter than the first distance. If the shortened distance is greater than a threshold amount (e.g., in the range of one millimeter to five millimeters), a controller may activate the tracking of the physical component 550.

In some examples, the pen structure 551 may enable a writing tip and an eraser. In some examples, since both the reflective markers are of unique size, the reflective sphere 552-1 may be used for writing, and the reflective sphere 552-2 may be used for erasing. In some examples, as the user presses the pen structure 551 against the surface/paper for writing, the inner tube (e.g., the inner elongated member 553) is moved against the bias member 556, which may cause a decrease (e.g., a slight decrease) in the distance between the two reflective markers. This distance change may be detected by the object tracker (e.g., the object tracker 100 of FIGS. 1A to 1G) based on identifying (e.g., uniquely identifying) the 3D coordinates of the two reflective markers, which indicates that the user will write sometime. In response to the distance change, an application may be launched on a mobile phone or AR headset device to visualize and track the writing. In some examples, the object tracker may provide pressure sensitivity by calibrating hand pressure against the distance between the reflective markers. For example, hand pressure is proportional to the distance between the reflective markers (e.g., since the higher the hand pressure, the lesser the distance between the markers would be). The object tracker may detect the distance between the markers and calibrate it against stroke intensity. The pressure variation from low to high while writing a particular word may be visualized with varying stroke intensities (e.g., a higher pressure may increase the boldness of the writing). In some examples, the object tracker may provide tilt sensitivity. In some examples, the object tracker may detect tilt based on 5DoF orientation available from the reflective markers, which may help artists to paint their drawings seamlessly.

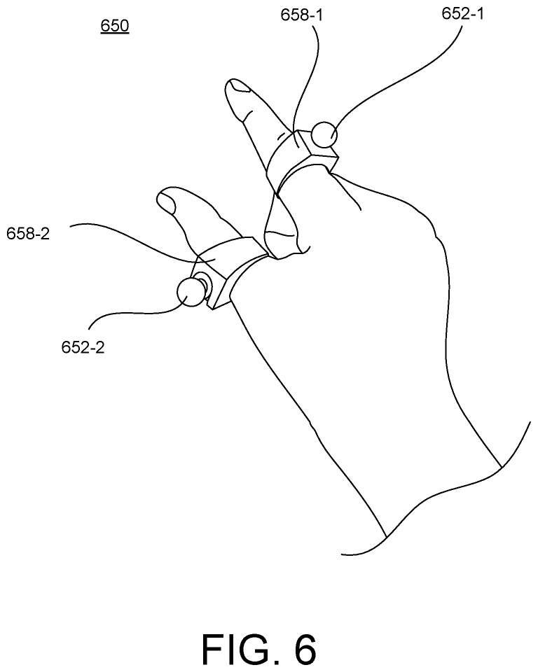

FIG. 6 illustrates an example of a physical component 650 according to another aspect. The physical component 650 may be an example of the physical component 150 of FIGS. 1A through 1G and may include any of the details discussed with reference to those figures. In some examples, the physical component 650 may be a controller that is used by the user to operate a UI interface. The physical component 650 includes a first ring member 658-1 configured to be placed over a finger (e.g., index finger) of a user. A reflective sphere 652-1 is coupled to the first ring member 658-1. The physical component 650 includes a second ring member 658-2 configured to be placed over another figure (e.g., thumb) of the user. A reflective sphere 652-2 is coupled to the second ring member 658-2. In some examples, the first ring member 658-1 may be used for user interactions with an AR or VR interface. In some examples, a gesture detector may cast a ray from the 3D coordinates of the reflective sphere 652-1 on the user's finger to the menu item to select the menu item. The gesture detector may be a sub-component incorporated into an application that uses the output of the object tracker or into the object tracker itself.

In some examples, the first ring member 658-1 may support user interactions such as taps, double tabs, and swipes. In some examples, the first ring member 658-1 and the second ring member 658-2 may be used together to make a pinch gesture. In some examples, the first ring member 658-1 may be used to control AR/VR menu objects such as buttons and sliders. In some examples, the first ring member 658-1 and the second ring member 658-2 may be used to perform a pinch gesture for selecting virtual objects and dragging them in an VR/AR environment.

In some examples, the user can tap on a menu button to select it with the index finger. In some examples, the gesture detector may detect a tap from the orientation (e.g., orientation 126). In some examples, the gesture detector may detect a tap based on the rate of change of velocity of the depth of the first ring member 658-1. As the user taps on a menu item, the finger moves forward, and the gesture detector detects the change in depth. In some examples, the gesture detector may identify a tap based on the change in depth of the first ring member 658-1 and the time to calculate finger velocity. In some examples, a tap is performed with a certain velocity, the gesture detector may use a threshold level (e.g., 1m/s) to detect a tap with the index finger. In some examples, taps are used to select menu items like buttons, dropdowns, and checkboxes. In some examples, the gesture detector may detect double tap. For example, the gesture detector may detect each tap, and the gesture detector may identify double taps by setting a threshold on the time between two consecutive taps. If two consecutive taps occur within a threshold level (e.g., 50 ms), the gesture detector can detect a double tap. In some examples, the gesture detector can detect a swipe. In some examples, the gesture detector may detect left and right swipes based on change in the 3D coordinates of the first ring member 658-1 between consecutive frames. In some examples, the gesture detector can detect a long press or a hold. As the user points the finger on an object or menu in the AR/VR user interface, the gesture detector may detect a long press or hold by identifying the stationary 3D coordinates in consecutive frames. In some examples, the gesture detector may detect a long press if the user holds for a threshold period of time (e.g., 1 second).

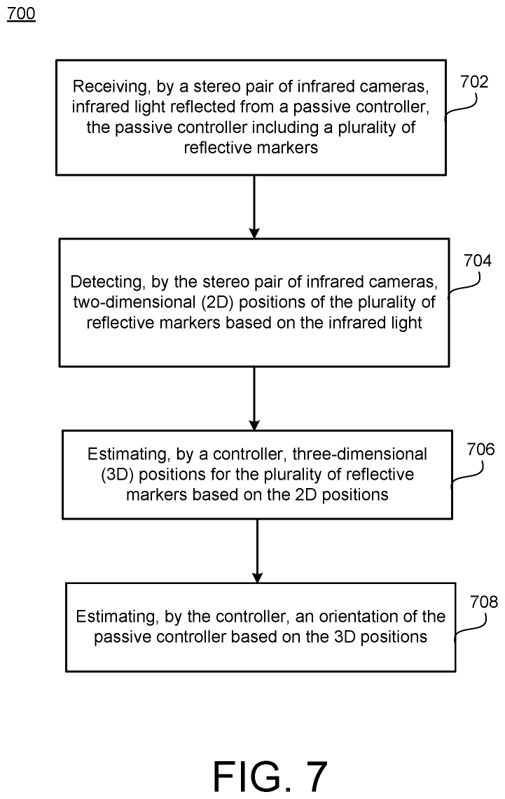

FIG. 7 illustrates a flowchart 700 depicting example operations of a computing device that tracks the orientation (e.g., six DoF position) of a physical component according to an aspect. Although the flowchart 700 is described with reference to the computing device 101 and the physical component 150 of FIGS. 1A through 1F, the flowchart 700 may be applicable to any of the embodiments herein.

Operation 702 includes receiving, by a stereo pair of infrared cameras (132L, 132R), infrared light 140 reflected from a physical component 150. The physical component 150 includes a plurality of reflective markers 152. Operation 704 includes detecting, by the stereo pair of infrared cameras (130-1, 130-2), 2D positions (e.g., 118L, 118R) of the plurality of reflective markers 152 based on the infrared light 140. Operation 706 includes estimating, by a controller 106, 3D positions 122 for the plurality of reflective markers 152 based on the 2D positions (e.g., 118L, 118R). Operation 708 includes estimating, by the controller 106, an orientation 126 of the physical component 150 based on the 3D positions 122.

Clause 1. A method comprising: receiving two-dimensional (2D) positions of at least one of a first reflective marker or a second reflective marker of a physical component; estimating a three-dimensional (3D) position of the first reflective marker and a 3D position of the second reflective marker based on the 2D positions; and computing an orientation of the physical component in 3D space based on the 3D position of the first reflective marker, the 3D position of the second reflective marker, and positioning information of the first and second reflective markers in the physical component.

Clause 2. The method of clause 1, further comprising: detecting a first 2D position of the first reflective marker based on reflected light received via a first camera; detecting a second 2D position of the first reflective marker based on reflected light received via a second camera; and estimating the 3D position of the first reflective marker based on the first 2D position and the second 2D position.

Clause 3. The method of clause 1 or 2, further comprising: determining that the second reflective marker is at least partially occluded; and estimating, by a neural network, the 3D position of the second reflective marker using 2D positions of the first reflective marker.

Clause 4. The method of clause 1 or 2, wherein the physical component includes the first reflective marker, the second reflective marker, and a third reflective marker, the method further comprising: determining that the second and third reflective markers are at least partially occluded; and estimating, by a neural network, 3D positions of the second and third reflective markers based on the 3D position of the first reflective marker and a 3D position of at least one of the first reflective marker, the second reflective marker, or the third reflective marker from a previous period of time.

Clause 5. The method of any of clauses 1 to 4, further comprising: computing an affine camera matrix based on the 2D positions of at least one of the first reflective marker or the second reflective marker; computing at least one metric projection matrix based on the affine camera matrix; generating calibration data based on the at least one metric projection matrix, the calibration data including at least one calibrated camera parameter; and configuring one or more infrared cameras with the at least one calibrated camera parameter.

Clause 6. The method of any of clauses 1 to 5, further comprising: computing a disparity of the first reflective marker based on a difference between a first 2D position of the first reflective marker from a first camera and a second 2D position of the first reflective marker from a second camera; and estimating the 3D position of the first reflective marker based on the disparity.

Clause 7. The method of any one of clauses 1 to 6, wherein the orientation of the physical component includes position data and rotation data of the physical component.

Clause 8. A computer program product comprising executable instructions that when executed by at least one processor cause the at least one processor to execute any of clauses 1 to 7.

Clause 9. A computing device comprising: a stereo pair of cameras configured to detect two-dimensional (2D) positions of at least one of a first reflective marker or a second reflective marker of a physical component; and a controller configured to: estimate a three-dimensional (3D) position of the first reflective marker and a 3D position of the second reflective marker based on the 2D positions; and compute an orientation of the physical component in 3D space based on the 3D position of the first reflective marker, the 3D position of the second reflective marker, and positioning information of the first and second reflective markers in the physical component.

Clause 10. The computing device of clause 9, wherein the controller is configured to: determine that the second reflective marker is at least partially occluded; and estimate, by a neural network, the 3D position of the second reflective marker using 2D positions of the first reflective marker.

Clause 11. The computing device of clause 9 or 10, wherein the stereo pair of cameras includes: a first camera configured to detect a first 2D position of the first reflective marker based on first reflected light; and a second camera configured to detect a second 2D position of the first reflective marker based on second reflected light, wherein the controller is configured to estimate the 3D position of the first reflective marker based on the first 2D position and the second 2D position.

Clause 12. The computing device of clause 11, further comprising: a plurality of first illuminators associated with the first camera; and a plurality of second illuminators associated with the second camera.

Clause 13. The computing device of any one of clauses 9 to 12, wherein the computing device includes a head-mounted display device, the head-mounted display device including a frame holding a pair of lenses and an arm portion coupled to the frame, wherein the stereo pair of infrared cameras are coupled to the frame and the controller is coupled to the arm portion.

Clause 14. The computing device of any one of clauses 9 to 13, wherein the physical component includes the first reflective marker, the second reflective marker, and a third reflective marker, the physical component including an elongated member connected to the first reflective marker, the second reflective marker, and the third reflective marker.

Clause 15. The computing device of any one of clauses 9 to 13, wherein the physical component includes a pen structure configured to enable the second reflective marker to move with respect to the first reflective marker.

Clause 16. The computing device of any one of clauses 9 to 13, wherein the physical component includes a first ring member coupled to the first reflective marker, and a second ring member coupled to the second reflective marker.

Clause 17. A computer program product storing executable instructions that when executed by at least one processor cause the at least one processor to execute operations, the operations comprising: receiving at least one two-dimensional (2D) position of at least one reflective marker of a physical component; estimating at least one three-dimensional (3D) position of the at least one reflective marker based on the at least one 2D position; and computing an orientation of the physical component in 3D space based on the at least one 3D position and positioning information of the at least one reflective marker in the physical component.

Clause 18. The computer program product of clause 17, wherein the operations further comprise: detecting at least one first 2D position for the at least one reflective marker based on reflected infrared light received via a first infrared camera; and detecting at least one second 2D position for the at least one reflective marker based on infrared light received via a second infrared camera.

Clause 19. The computer program product of clause 17 or 18, wherein the at least one reflective marker includes a first reflective marker and a second reflective marker, wherein the operations further comprise: determining that the second reflective marker is at least partially occluded; and estimating, by a neural network, a 3D position of the second reflective marker using at least one 2D position of the first reflective marker.

Clause 20. The computer program product of clause 17 or 18, wherein the at least one reflective marker includes a first reflective marker, a second reflective marker, and a third reflective marker, wherein the operations further comprise: determining that the second and third reflective markers are at least partially occluded; and estimating, by a neural network, 3D positions of the second and third reflective markers based on a 3D position of the first reflective marker and a 3D position of at least one of the first reflective marker, the second reflective marker, or the third reflective marker from a previous period of time.

Clause 21. The computer program product of any of clauses 17 to 20, wherein the orientation of the physical component includes a six degrees of freedom (6DoF) orientation of the physical component.

Clause 22. A method comprising: receiving at least one two-dimensional (2D) position of at least one reflective marker of a physical component; estimating at least one three-dimensional (3D) position of the at least one reflective marker based on the at least one 2D position; and computing an orientation of the physical component in 3D space based on the at least one 3D position and positioning information of the at least one reflective marker in the physical component.

Clause 23. The method of clause 22, further comprising: detecting at least one first 2D position for the at least one reflective marker based on reflected infrared light received via a first infrared camera; and detecting at least one second 2D position for the at least one reflective marker based on infrared light received via a second infrared camera.

Clause 24. The method of clause 22 or 23, wherein the at least one reflective marker includes a first reflective marker and a second reflective marker, wherein the method further comprises: determining that the second reflective marker is at least partially occluded; and estimating, by a neural network, a 3D position of the second reflective marker using at least one 2D position of the first reflective marker.

Clause 25. The method of clause 22 or 23, wherein the at least one reflective marker includes a first reflective marker, a second reflective marker, and a third reflective marker, wherein the method further comprises: determining that the second and third reflective markers are at least partially occluded; and estimating, by a neural network, 3D positions of the second and third reflective markers based on a 3D position of the first reflective marker and a 3D position of at least one of the first reflective marker, the second reflective marker, or the third reflective marker from a previous period of time.

Clause 26. The method of any of clauses 22 to 25, wherein the orientation of the physical component includes a six degrees of freedom (6DoF) orientation of the physical component. Claim 27. A computing device comprising: a stereo pair of cameras configured to detect at least one two-dimensional (2D) position of at least one reflective marker of a physical component; and a controller configured to: estimate at least one three-dimensional (3D) position of the at least one reflective marker based on the at least one 2D position; and compute an orientation of the physical component in 3D space based on the at least one 3D position and positioning information of the at least one reflective marker in the physical component.

Clause 28. The computing device of claim 27, wherein the stereo pair of cameras include a first camera configure to detect at least one first 2D position for the at least one reflective marker based on reflected infrared light received; and a second camera configured to detect at least one second 2D position for the at least one reflective marker based on infrared light.

Clause 29. The computing device of clause 27 or 28, wherein the at least one reflective marker includes a first reflective marker and a second reflective marker, wherein the controller is configured to determine that the second reflective marker is at least partially occluded; and estimate, by a neural network, a 3D position of the second reflective marker using at least one 2D position of the first reflective marker.

Clause 30. The computing device of clause 27 or 28 wherein the at least one reflective marker includes a first reflective marker, a second reflective marker, and a third reflective marker, wherein the controller is configured to determine that the second and third reflective markers are at least partially occluded; and estimate, by a neural network, 3D positions of the second and third reflective markers based on a 3D position of the first reflective marker and a 3D position of at least one of the first reflective marker, the second reflective marker, or the third reflective marker from a previous period of time.

Clause 31. The computing device of any of clauses 27 to 30, wherein the orientation of the physical component includes a six degrees of freedom (6DoF) orientation of the physical component.

Clause 32. The computing device of any of clauses 27 to 31, further comprising: a plurality of first illuminators associated with the first camera; and a plurality of second illuminators associated with the second camera.

Clause 33. The computing device of any one of clauses 27 to 32, wherein the computing device includes a head-mounted display device.

Clause 34. The computing device of clause 33, wherein the head-mounted display device includes a frame holding a pair of lenses and an arm portion coupled to the frame, wherein the stereo pair of infrared cameras are coupled to the frame and the controller is coupled to the arm portion.

Clause 35. The computing device of any one of clauses 27 to 34, wherein the physical component includes the first reflective marker, the second reflective marker, and a third reflective marker, the physical component including an elongated member connected to the first reflective marker, the second reflective marker, and the third reflective marker.

Clause 36. The computing device of any one of clauses 27 to 34, wherein the physical component includes a pen structure configured to enable the second reflective marker to move with respect to the first reflective marker.

Clause 37. The computing device of any one of clauses 27 to 34, wherein the physical component includes a first ring member coupled to the first reflective marker, and a second ring member coupled to the second reflective marker.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. In addition, the term “module” may include software and/or hardware.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”. Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

To provide for interaction with a user, the systems and techniques described here can be implemented on a computer having a display device (e.g., a LED (light emitting diode) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

What is claimed is:

1. A method comprising:
receiving two-dimensional (2D) positions of at least one of a first reflective marker or a second reflective marker of a physical component;
estimating a three-dimensional (3D) position of the first reflective marker and a 3D position of the second reflective marker based on the 2D positions; and
computing an orientation of the physical component in 3D space based on the 3D position of the first reflective marker, the 3D position of the second reflective marker, and positioning information of the first and second reflective markers in the physical component.

2. The method of claim 1, further comprising:
detecting a first 2D position of the first reflective marker based on reflected light received via a first camera;
detecting a second 2D position of the first reflective marker based on reflected light received via a second camera; and
estimating the 3D position of the first reflective marker based on the first 2D position and the second 2D position.

3. The method of claim 1, further comprising:
determining that the second reflective marker is at least partially occluded; and
estimating, by a neural network, the 3D position of the second reflective marker using 2D positions of the first reflective marker.

4. The method of claim 1, wherein the physical component includes the first reflective marker, the second reflective marker, and a third reflective marker, the method further comprising:
determining that the second and third reflective markers are at least partially occluded; and
estimating, by a neural network, 3D positions of the second and third reflective markers based on the 3D position of the first reflective marker and a 3D position of at least one of the first reflective marker, the second reflective marker, or the third reflective marker from a previous period of time.

5. The method of claim 1, further comprising:
computing an affine camera matrix based on the 2D positions of at least one of the first reflective marker or the second reflective marker;
computing at least one metric projection matrix based on the affine camera matrix;
generating calibration data based on the at least one metric projection matrix, the calibration data including at least one calibrated camera parameter; and
configuring one or more infrared cameras with the at least one calibrated camera parameter.

6. The method of claim 1, further comprising:
computing a disparity of the first reflective marker based on a difference between a first 2D position of the first reflective marker from a first camera and a second 2D position of the first reflective marker from a second camera; and
estimating the 3D position of the first reflective marker based on the disparity.

7. The method of claim 1, wherein the orientation of the physical component includes position data and rotation data of the physical component.

8. A computing device comprising:
a stereo pair of cameras configured to detect two-dimensional (2D) positions of at least one of a first reflective marker or a second reflective marker of a physical component; and
a controller configured to:
estimate a three-dimensional (3D) position of the first reflective marker and a 3D position of the second reflective marker based on the 2D positions; and
compute an orientation of the physical component in 3D space based on the 3D position of the first reflective marker, the 3D position of the second reflective marker, and positioning information of the first and second reflective markers in the physical component.

9. The computing device of claim 8, wherein the controller is configured to:
determine that the second reflective marker is at least partially occluded; and
estimate, by a neural network, the 3D position of the second reflective marker using 2D positions of the first reflective marker.

10. The computing device of claim 8, wherein the stereo pair of cameras includes:
a first camera configured to detect a first 2D position of the first reflective marker based on first reflected light; and
a second camera configured to detect a second 2D position of the first reflective marker based on second reflected light, wherein the controller is configured to estimate the 3D position of the first reflective marker based on the first 2D position and the second 2D position.

11. The computing device of claim 10, further comprising:
a plurality of first illuminators associated with the first camera; and
a plurality of second illuminators associated with the second camera.

12. The computing device of claim 8, wherein the computing device includes a head-mounted display device, the head-mounted display device including a frame holding a pair of lenses and an arm portion coupled to the frame, wherein the stereo pair of infrared cameras are coupled to the frame and the controller is coupled to the arm portion.

13. The computing device of claim 8, wherein the physical component includes the first reflective marker, the second reflective marker, and a third reflective marker, the physical component including an elongated member connected to the first reflective marker, the second reflective marker, and the third reflective marker.

14. The computing device of claim 8, wherein the physical component includes a pen structure configured to enable the second reflective marker to move with respect to the first reflective marker.

15. The computing device of claim 8, wherein the physical component includes a first ring member coupled to the first reflective marker, and a second ring member coupled to the second reflective marker.

16. A non-transitory computer-readable medium storing executable instructions that when executed by at least one processor cause the at least one processor to execute operations, the operations comprising:
receiving at least one two-dimensional (2D) position of at least one reflective marker of a physical component;
estimating at least one three-dimensional (3D) position of the at least one reflective marker based on the at least one 2D position; and
computing an orientation of the physical component in 3D space based on the at least one 3D position and positioning information of the at least one reflective marker in the physical component.

17. The non-transitory computer-readable medium of claim 16, wherein the operations further comprise:
detecting at least one first 2D position for the at least one reflective marker based on reflected infrared light received via a first infrared camera; and
detecting at least one second 2D position for the at least one reflective marker based on infrared light received via a second infrared camera.

18. The non-transitory computer-readable medium of claim 16, wherein the at least one reflective marker includes a first reflective marker and a second reflective marker, wherein the operations further comprise:
determining that the second reflective marker is at least partially occluded; and
estimating, by a neural network, a 3D position of the second reflective marker using at least one 2D position of the first reflective marker.

19. The non-transitory computer-readable medium of claim 16, wherein the at least one reflective marker includes a first reflective marker, a second reflective marker, and a third reflective marker, wherein the operations further comprise:
determining that the second and third reflective markers are at least partially occluded;
and estimating, by a neural network, 3D positions of the second and third reflective markers based on a 3D position of the first reflective marker and a 3D position of at least one of the first reflective marker, the second reflective marker, or the third reflective marker from a previous period of time.

20. The non-transitory computer-readable medium of claim 16, wherein the orientation of the physical component includes a six degrees of freedom (6DoF) orientation of the physical component.
